(19) United States
(12) Patent Application Publication
(10) Pub. No.: US 2016/0323891 A1
(43) Pub. Date: Nov. 3, 2016

(54) METHOD, APPARATUS, AND SYSTEM FOR COLLABORATIVE COMMUNICATION BETWEEN USER EQUIPMENTS

(71) Applicant: HUAWEI TECHNOLOGIES CO.,LTD., Shenzhen (CN)

(72) Inventors: Lei Zhang, Shenzhen (CN); Yi Wang, Shanghai (CN); Dageng Chen, Shanghai (CN)

(73) Assignee: HUAWEI TECHNOLOGIES CO.,LTD., Shenzhen (CN)

(21) Appl. No.: 15/203,780

(22) Filed: Jul. 6, 2016

Related U.S. Application Data
(63) Continuation of application No. PCT/CN2014/070218, filed on Jan. 7, 2014.

(51) Int. Cl. H04W 72/08; H04W 8/24; H04W 72/04

(52) U.S. Cl. CPC H04W 72/08; H04W 72/0413; H04W 72/042; H04W 8/245; H04W 88/04

(57) ABSTRACT

The present patent application provides a method, an apparatus, and a system for collaborative communication between a network device and two or more terminal devices. The network device receives a collaboration request from a first terminal device. The network device determines, according to the collaboration request, at least one second terminal device that may collaborate with the first terminal device in receiving downlink data. The network device sends an indication message to the first terminal device. The indication message instructs the first terminal device to receive a first part of the downlink data from the network device, and receive a second part of the downlink data, which is transmitted from the network device to the second terminal device, from the second terminal device.

### CROSS-REFERENCE TO RELATED APPLICATIONS

This application is a continuation of International Application No. PCT/CN2014/070218, filed on Jan. 7, 2014, which is hereby incorporated by reference in its entirety.

### TECHNICAL FIELD

The present patent application relates to the field of communications technologies, and in particular, to a method, an apparatus, and a system for collaborative communication between terminal devices.

### BACKGROUND

Multiple-input multiple-output (MIMO) is a technology used in a multi-antenna wireless communications system. In MIMO, multiple antennas can be used at a transmitting end to separately and independently send signals, and multiple antennas are used at a receiving end to receive and restore original information sent from the transmitting end. This technology has very good effects in suppressing channel fading, implementing spatial multiplexing or transmit diversity, reducing bit error rates, increasing transmission rates, and improving transmission quality.

For terminal devices (also called user equipment or UE), increasing quantity of antennas is one of important means for improving spectral efficiency and system capacity.

In the existing technology, because terminal devices are limited by factors such as volume, channel relevancy, antenna size, and costs, it is difficult to increase the quantity of antennas in a terminal device. Because performance of spatial multiplexing or transmit diversity is affected by the quantity of antennas, transmission rate or transmission quality of the terminal devices is not high.

### SUMMARY

Embodiments of the present application provide a method, an apparatus, and a system for collaborative communication between terminal devices, so that a terminal device obtains a diversity gain or a multiplexing gain on a premise that a quantity of physical antennas of the terminal device is not increased.

According to a first aspect, an embodiment of the present application provides a method for collaborative communication between terminal devices. The method includes: receiving, by a network device, a collaboration request from a first terminal device; determining, by the network device according to the collaboration request, at least one second terminal device that collaborates with the first terminal device in receiving first downlink data; and sending, by the network device, a first indication message to the first terminal device. The first indication message is used to instruct the first terminal device to receive a first part of the first downlink data from the network device and receive a second part of the first downlink data from the second terminal device.

According to a second aspect, an embodiment of the present application provides a method for collaborative communication. The method includes: sending, by a first terminal device, a collaboration request to a network device; receiving, by the first terminal device, a first indication message from the network device. The first indication message is used to instruct the first terminal device to receive a first part of the first downlink data from the network device and receive a second part of the first downlink data from a second terminal device. The method further includes: receiving, by the first terminal device, the first part of the first downlink data from the network device, and receiving the second part of the first downlink data from the second terminal device.

According to a third aspect, an embodiment of the present application provides a method for collaborative communication. The method includes: receiving, by a second terminal device, a second part of first downlink data from a network device; and forwarding, by the second terminal device, the second part of the first downlink data to the first terminal device. A first part of the first downlink data is sent by the network device to the first terminal device.

According to a fourth aspect, an embodiment of the present application provides a network device for collaborative communication. The network device includes: a receiver, configured to receive a collaboration request from a first terminal device; a processor, configured to determine, according to the collaboration request, at least one second terminal device that collaborates with the first terminal device in receiving first downlink data; and a transmitter, configured to send a first indication message to the first terminal device. The first indication message is used to instruct the first terminal device to receive a first part of the first downlink data from the network device and receive a second part of the first downlink data from the second terminal device.

According to a fifth aspect, an embodiment of the present application provides a terminal device. The terminal device includes: a transmitter, configured to send a collaboration request to a network device; and a receiver, configured to receive a first indication message from the network device, the first indication message is used to instruct the terminal device to receive a first part of the first downlink data from the network device; and receive a second indication message from the network device. The second indication message is used to instruct the first terminal device to receive the second part of the first downlink data from another terminal device. The receiver is further configured to receive the first part of the first downlink data from the network device, and receive the second part of the first downlink data from the other terminal device.

According to a sixth aspect, an embodiment of the present application further provides a system for collaborative communication between terminal devices. The system includes a network device, a first terminal device and a second terminal device.

According to the method, the apparatus, and the system for collaborative communication between terminal devices provided in the embodiments of the present patent application, after receiving a collaboration request from a first terminal device, a network device determines, for the first terminal device, at least one second terminal device that collaborates with the first terminal device in receiving downlink data. The network device indicates, to the first terminal device by using an indication message, that the downlink data may be received separately by using the network device and the second terminal device. In this way, on a premise that quantity of physical antennas of the terminal device is not increased, quality of data reception at the first terminal device can be improved, a bit error rate can be reduced, and a diversity gain can be obtained. In addition, a channel capacity can be increased, a beneficial effect of “spatial multiplexing” can be achieved, and a multiplexing gain can be obtained.

### BRIEF DESCRIPTION OF DRAWINGS

The following briefly introduces the accompanying drawings used for describing the embodiments.

FIG. 1 is a flowchart of a method for collaborative communication between terminal devices according to an embodiment of the present application;

FIG. 2 is a flowchart of a method for collaborative communication between terminal devices according to another embodiment of the present application;

FIG. 3 is a flowchart of a method for collaborative communication between terminal devices according to still another embodiment of the present application;

FIG. 4 is a schematic diagram of a specific implementation manner in which a second terminal device collaborates with a first terminal device in receiving first downlink data, but the first terminal device does not collaborate with the second terminal device;

FIG. 5 is a schematic diagram of a specific implementation manner in which a second terminal device collaborates with a first terminal device in receiving first downlink data and the first terminal device collaborates with the second terminal device in receiving second downlink data;

FIG. 6 is a block diagram of a network device according to an embodiment of the present application;

FIG. 7 is a block diagram of a terminal device according to an embodiment of the present application;

FIG. 8 is a block diagram of a terminal device according to another embodiment of the present application;

FIG. 9 is a block diagram of a network device according to another embodiment of the present application; and

FIG. 10 is a block diagram of a terminal device according to still another embodiment of the present application; and

### DETAILED DESCRIPTION

Technologies described in this specification may be applied to various communications systems including current second generation (2G) and third generation (3G) communications systems, and next-generation communications systems. For example, Global System for Mobile Communications (GSM), Code Division Multiple Access (CDMA) systems, Time Division Multiple Access (TDMA) systems, Wideband Code Division Multiple Access (WCDMA) systems, Frequency Division Multiple Access (FDMA) systems, Orthogonal Frequency-Division Multiple Access (OFDMA) systems, single-carrier FDMA (SC-FDMA) systems, general packet radio service (GPRS) systems, Long Term Evolution (LTE) systems, etc.

Terminal devices involved in this application may be a wireless terminal or a wired terminal. The wireless terminal may refer to a device that provides a user with voice and/or data connectivity, a handheld device with a radio connection function, or any other processing devices that can be connected to a radio modem. The wireless terminal may communicate with one or more core networks through a radio access network (RAN). The wireless terminal may be a mobile terminal, such as a mobile phone (also referred to as a “cellular” phone) and a computer with a mobile terminal, for example, may be a portable, pocket-sized, handheld, computer built-in, or in-vehicle mobile apparatus, which exchanges voice and/or data with the radio access network. For example, the wireless terminal may be a device such as a personal communication service (PCS) phone, a cordless telephone set, a Session Initiation Protocol (SIP) phone, a wireless local loop (WLL) station, or a personal digital assistant (PDA). The wireless terminal may also be referred to as a system, a subscriber unit, a subscriber station, a mobile station, a mobile terminal (Mobile), a remote station, an access point, a remote terminal, an access terminal, a user terminal, a user agent, a user device, or user equipment.

A network device involved in this application may be, for example, a base station or a radio network controller (RNC).

The base station (for example, an access point) may be an ordinary base station (BTS) in GSM or CDMA, may be a conventional base station (NodeB) in WCDMA, or may be an evolved NodeB (eNB or e-NodeB) in LTE. Types of the base stations are not limited in the present application.

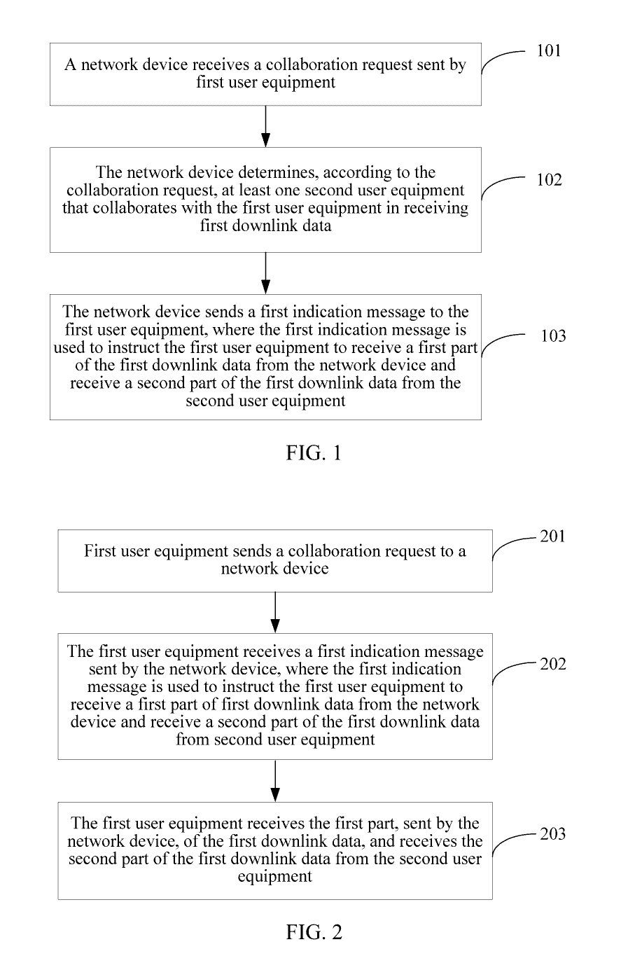

FIG. 1 is a flowchart of a method for collaborative communication between terminal devices according to an embodiment of the present application. As shown in FIG. 1, the method includes:

Step 101: A network device receives a collaboration request from a first terminal device.

Step 102: The network device determines, according to the collaboration request, at least one second terminal device that collaborates with the first terminal device in receiving first downlink data.

Step 103: The network device sends a first indication message to the first terminal device, where the first indication message instructs the first terminal device to receive a first part of the first downlink data from the network device and receive a second part of the first downlink data from the second terminal device.

The collaboration request may carry an identifier of the first terminal device, to uniquely indicate the first terminal device in a network. In addition, the collaboration request may further carry a parameter such as description information of quality of a link between the first terminal device and the second terminal device.

Optionally, if a downlink quality is not good, a bit error rate when the first terminal device receives downlink data from the network device is higher than a predetermined value, and in this case, the first part and the second part of the first downlink data may be the same. If the downlink quality is good, a bit error rate when the first terminal device receives downlink data from the network device is lower than a predetermined value, and in this case, the first part and the second part of the first downlink data may be different.

In this embodiment of the present application, there may be one or more second terminal devices that may collaborate with the first terminal device in receiving the first downlink data. The network device determines a second terminal device that collaborates with the first terminal device in receiving the first downlink data. The determination is based on information that is previously reported by the first terminal device or the second terminal device. The information may include quality of a link between the first and second terminal device, quality of a link between the first terminal device and the network device, and quality of a link between the second terminal device and the network device. Based on such information, the network device may first determine whether the collaboration of the second terminal device with the first terminal device can bring a beneficial effect for the first terminal device. For example, whether a multiplexing gain or diversity gain can be brought for the first terminal device. If the beneficial effect cannot reach a predetermined value, the network device may not select the second terminal device and instead selects another second terminal device to collaborate with the first terminal device.

After determining the second terminal device for collaborating with the first terminal device, the network device may adjust a transmission rate level according to the quality of the link between the first and second terminal devices. For example, when the quality of the link between the first and second terminal devices is not good, a rate when the second terminal device collaborates with the first terminal device in receiving data is limited. In this case, rates at which the network device sends the first and second parts of the first downlink data should also be reduced, otherwise data cannot be processed in time or sent in time when the second terminal device collaborates with the first terminal device, and finally, collaboration cannot be performed normally. A mapping table about “quality of a link between terminal devices—rate of transmission between terminal devices—data sending rate of the network device—data sending level of the network device” may be established for the network device, and the network device may select a proper transmission rate level according to the mapping table.

The network device may add an identifier of the second terminal device to the first indication message, and may further add information such as a time at which the second terminal device starts to collaborate with the first terminal device, so that the second terminal device can assist more precisely in receiving the downlink data.

As a feasible implementation manner, after determining that the second terminal device collaborates with the first terminal device, the network device may send a second indication message to the second terminal device. The second indication message instructs the second terminal device to forward the second part of the first downlink data, which is received from the network device, to the first terminal device.

As another feasible implementation manner, the first terminal device may negotiate with the second terminal device in advance, so that the second terminal device receives the second part of the first downlink data from the network device and forwards the second part of the first downlink data to the first terminal device.

Optionally, after the network device receives the collaboration request sent by the first terminal device, if the network device determines that the network device having second downlink data to be sent to the second terminal device, the network device may further determine that the first terminal device collaborates with the second terminal device in receiving the second downlink data. In this implementation scenario, the network device may further send a third indication message to the second terminal device, to instruct the second terminal device to receive a first part of the second downlink data from the network device and receive a second part of the second downlink data from the first terminal device. It should be noted that the second indication message and the third indication message may be the same. That is, when instructing the second terminal device to forward the second part of the first downlink data to the first terminal device, the network device may also instruct the second terminal device to receive the first part of the second downlink data from the network device and receive the second part of the second downlink data from the first terminal device.

Similar to a scenario in which the second terminal device assists the first terminal device, in a feasible implementation manner, in a scenario in which the first terminal device assists the second terminal device, the network device may further send a fourth indication message to the first terminal device, to instruct the first terminal device to forward the second part, received from the network device, of the second downlink data to the second terminal device. In another feasible implementation manner, the first terminal device may also negotiate with the second terminal device in advance, so that the first terminal device receives the second part of the second downlink data from the network device and forwards the second part of the second downlink data to the second terminal device.

It should be noted that the first indication message and the fourth indication message may also be a same message. That is, when indicating the first terminal device to forward the second part, received from the network device, of the second downlink data to the second terminal device, the network device may also indicate the first terminal device to receive the first part of the first downlink data from the network device and receive the second part of the first downlink data from the second terminal device.

Specifically, the network device may determine whether communication quality of the first terminal device and communication quality of the second terminal device satisfy a preset threshold in a case in which the second terminal device collaborates with the first terminal device in receiving the first downlink data and the first terminal device collaborates with the second terminal device in receiving the second downlink data. If the preset threshold is satisfied, the network device may determine that the first terminal device collaborates with the second terminal device in receiving the second downlink data. In this way, the second terminal device can obtain a multiplexing gain or a diversity gain.

It should be noted that the network device may determine, according to the quality of the link between the first and second terminal devices, the quality of the link between the first terminal device and the network device, and the quality of the link between the second terminal device and the network device that are previously reported by the first terminal device or the second terminal device, effects on the communication quality of the first and second terminal devices after the first terminal device collaborates with the second terminal device and the second terminal device collaborates with the first terminal device. If communication quality of either the first terminal device or the second terminal device does not satisfy the preset threshold or does not reach a predetermined multiplexing gain or diversity gain effect because the first terminal device collaborates with the second terminal device and the second terminal device collaborates with the first terminal device, the first terminal device and the second terminal device may not perform collaborative communication. In this implementation scenario, the network device may change a collaboration relationship, for example, cancel the collaboration of the first terminal device with the second terminal device or cancel the collaboration of the second terminal device with the first terminal device or cancel the two collaborations.

Optionally, based on the foregoing embodiment, after the network device determines, according to the collaboration request, the at least one second terminal device that collaborates with the first terminal device in receiving the first downlink data, the network device may further send a first cell radio network temporary identifier (C-RNTI) to each second terminal device. Each second terminal device demodulates control information of the first downlink data according to the first C-RNTI. Alternatively, the network device sends a first C-RNTI to at least any one of the second terminal devices, so that all the second terminal devices share the first C-RNTI.

Further, after receiving the first C-RNTI, the second terminal device may demodulate a physical downlink control channel (PDCCH) of the first terminal device, to acquire control information of the first terminal device, so that the second terminal device sends the second part of the first downlink data to the first terminal device. For example, after demodulating the PDCCH of the first terminal device, the second terminal device may learn a time-frequency resource block occupied by the second part of the first downlink data, learn a reception mode of the first terminal device (for example, whether the reception mode is spatial multiplexing or transmit diversity), and learn control information such as a discontinuous reception (DRX) configuration. When necessary, the network device may adjust a configuration parameter of the first terminal device or the second terminal device, so that related configuration parameters of the first terminal device and the second terminal device are the same (for example, paging groups are the same, DRXs are the same, and feedback periods are the same), to implement efficient collaboration between the first terminal device and the second terminal device. Frequency used by the communications link between the first terminal device and the second terminal device may be out-of-band frequency. A specific communication manner may be, for example, performing communication by using a device-to-device (D2D) communication protocol. The first C-RNTI may be a C-RNTI of the first terminal device or a C-RNTI of the second terminal device or a preset C-RNTI.

In this embodiment, a base station may scramble a control channel by using the C-RNTI of the first terminal device or the C-RNTI of the second terminal device or another preset C-RNTI. Therefore, correspondingly, the first C-RNTI sent by the base station to the second terminal device should be the C-RNTI of the first terminal device or the C-RNTI of the second terminal device or the another preset C-RNTI respectively.

According to the method provided in this embodiment, after receiving a collaboration request of first terminal device, a network device may determine, for the terminal device, at least one other second terminal device that collaborates with the first terminal device in receiving downlink data, and indicate, to the first terminal device by using an indication message, that the downlink data may be received separately by using the network device and the second terminal device. In this way, on a premise that a quantity of physical antennas of terminal device is not increased, quality of data reception performed by the terminal device can be improved, a bit error rate can be reduced, and a diversity gain can be obtained. In addition, a channel capacity can be increased, a beneficial effect of “spatial multiplexing” can be achieved, and a multiplexing gain can be obtained.

FIG. 2 is a flowchart of a method for collaborative communication between terminal devices according to another embodiment of the present application. As shown in FIG. 2, the method in this embodiment may include:

Step 201: First terminal device sends a collaboration request to a network device.

Step 202: The first terminal device receives a first indication message sent by the network device, where the first indication message instructs the first terminal device to receive a first part of first downlink data from the network device and receive a second part of the first downlink data from second terminal device.

Step 203: The first terminal device receives the first part of the first downlink data from the network device, and receives the second part of the first downlink data from the second terminal device.

Further, the first terminal device may further receive a fourth indication message that is sent by the network device and is used to instruct the first terminal device to forward a second part, received from the network device, of second downlink data to the second terminal device. Alternatively, the first terminal device may further negotiate with the second terminal device in advance, so that the first terminal device receives a second part of second downlink data from the network device and forwards the second part of the second downlink data to the second terminal device.

It should be noted that the first indication message and the fourth indication message may also be the same. That is, when indicating the first terminal device to forward the second part, received from the network device, of the second downlink data to the second terminal device, the network device may further instruct the first terminal device to receive the first part of the first downlink data from the network device and receive the second part of the first downlink data from the second terminal device.

In this implementation scenario, after receiving the second part, sent by the network device, of the second downlink data, the first terminal device sends the second part of the second downlink data to the second terminal device.

Further, when the second terminal device collaborates with the first terminal device, if the network device determines that the second terminal device is also receiving downlink user data from the network device, the first terminal device can also collaborate with the second terminal device at the same time, so that the second terminal device obtains a multiplexing gain or a diversity gain.

Further, after the first terminal device sends the collaboration request to the network device, the first terminal device may further receive a second C-RNTI sent by the network device. The first terminal device may demodulate control information of the second downlink data according to the second C-RNTI.

The first terminal device decodes a PDCCH of the second terminal device by using the second C-RNTI, to acquire control information of the second terminal device, so that the first terminal device sends the second part of the second downlink data to the second terminal device.

Further, the second C-RNTI may be a C-RNTI of the second terminal device or a C-RNTI of the first terminal device or a preset C-RNTI.

According to the method provided in this embodiment, first terminal device may send a collaboration request to a network device, and the network device may determine at least one other terminal device that collaborates with the first terminal device in receiving downlink data, and indicate, to the terminal device by using an indication message, that the downlink data may be received separately by using the network device and another terminal device. In this way, on a premise that a quantity of physical antennas of terminal device is not increased, quality of data reception performed by the terminal device can be improved, a bit error rate can be reduced, and a diversity gain can be obtained. In addition, a channel capacity can be increased, a beneficial effect of “spatial multiplexing” can be achieved, and a multiplexing gain can be obtained.

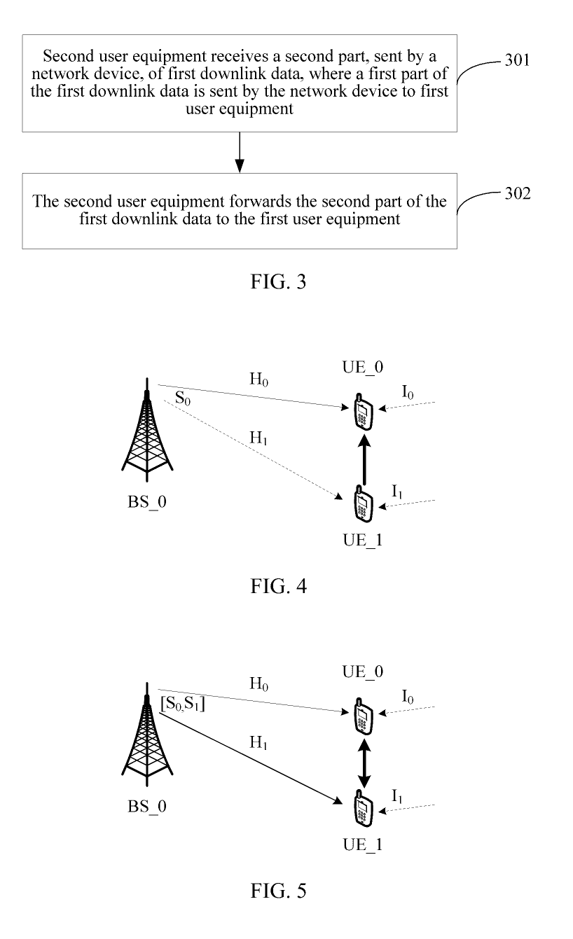

FIG. 3 is a flowchart of a method for collaborative communication between terminal devices according to still another embodiment of the present application. As shown in FIG. 3, the method in this embodiment may include:

Step 301: Second terminal device receives a second part of first downlink data from a network device, where a first part of the first downlink data is sent by the network device to first terminal device.

Step 302: The second terminal device forwards the second part of the first downlink data to the first terminal device.

As a feasible implementation manner, after determining that the second terminal device collaborates with the first terminal device, the network device may send a second indication message to the second terminal device, where the second indication message instructs the second terminal device to forward the second part of the first downlink data received from the network device to the first terminal device. As another feasible implementation manner, the first terminal device may further negotiate with the second terminal device in advance, so that the second terminal device receives the second part of the first downlink data from the network device and forwards the second part of the first downlink data to the first terminal device.

Further, before the second terminal device receives the second part of the first downlink data from the network device, the second terminal device may further receive a first C-RNTI from the network device, and the second terminal device may demodulate control information of the first downlink data according to the first C-RNTI.

The second terminal device decodes a PDCCH of the first terminal device by using the first C-RNTI, to acquire control information of the first terminal device, so that the second terminal device sends the second part of the first downlink data to the first terminal device.

Further, the second terminal device is main terminal device among all terminal devices that collaborate with the first terminal device in receiving the first downlink data. Before the second terminal device receives the second part of the first downlink data from the network device, the second terminal device may further receive the first C-RNTI from the network device. The main terminal device may demodulate the control information of the first downlink data according to the first C-RNTI. Optionally, there may be one or more main terminal devices among the second terminal devices. When there is one main terminal device among the second terminal devices, only the one main terminal device demodulates the PDCCH of the first terminal device, and the one main terminal device shares the control information, obtained by means of demodulation, of the first terminal device with the other terminal devices among the second terminal devices. When there are multiple main terminal devices among the second terminal devices, the multiple main terminal devices all need to demodulate the PDCCH of the first terminal device. If some main terminal devices among the multiple main terminal devices fail to receive the first C-RNTI from the network device, the main terminal device that receives the first C-RNTI needs to share the first C-RNTI with other main terminal devices that fail to receive the first C-RNTI.

Further, the first C-RNTI may be a C-RNTI of the first terminal device or a C-RNTI of the second terminal device or a preset C-RNTI.

Optionally, the second terminal device may receive a third indication message sent by the network device, where the third indication message is further used to instruct the second terminal device to receive a first part of second downlink data from the network device and receive a second part of the second downlink data from the first terminal device. Alternatively, the second terminal device negotiates with the first terminal device, so that the first terminal device receives a second part of second downlink data from the network device and forwards the second part of the second downlink data to the second terminal device.

According to the method provided in this embodiment, after receiving a collaboration request of first terminal device, a network device may determine, for the terminal device, at least one other second terminal device that collaborates with the first terminal device in receiving downlink data. The network device indicates, to the first terminal device by using an indication message, that the downlink data may be received separately by using the network device and the second terminal device. In this way, on a premise that a quantity of physical antennas of terminal device is not increased, quality of data reception performed by the terminal device can be improved, a bit error rate can be reduced, and a diversity gain can be obtained. In addition, a channel capacity can be increased, a beneficial effect of “spatial multiplexing” can be achieved, and a multiplexing gain can be obtained.

The following describes, by using two specific examples, the method for collaborative communication between terminal devices that is provided in the present application. FIG. 4 provides a schematic diagram of a specific implementation manner in which second terminal device collaborates with first terminal device in receiving first downlink data but the first terminal device does not collaborate with the second terminal device. As shown in FIG. 4, a network device, for example, a base station BS_0, needs to send information S₀ (which may be multiple layers of information, i.e. S₀[s0, s1 . . . sp]T) to first terminal device UE_0. Due to a feature of radio space propagation of downlink data, second terminal device UE_1 can receive downlink data S₀ from BS_0. A system model of downlink data reception performed by the first terminal device UE_0 may be described by using the following formulas:

Y₀=H₀·P₁·S₀+I₀+N₀, and

Y₁=H₁·P₁·S₀+I₁+N₁,

where Y₀ represents downlink data received by the first terminal device UE_0, and Y₁ represents downlink data received by the second terminal device UE_1. H₁ (j=0 or 1) represents a spatial channel between the base station BS_0 and terminal device j, P₁ is a precoding matrix (or vector), I₀ and I₁ represent interfering downlink data received by the two terminal devices in addition to S₀, and N_{J}=0 or 1) represents a noise signal received by the terminal device j. In a case in which the terminal devices do not collaborate with each other, for UE_1, H₁·P₁·S₀ is useless (interfering) downlink data, cannot be used, and cannot be provided for use by the first terminal device UE_0.

The second terminal device UE_1 may share, with the other party by means of collaborative communication, the downlink data Y₁ received by the second terminal device UE_1. After receiving the information Y₁ shared by the second terminal device UE_1, the first terminal device UE_0 may obtain information H₁·P₁ by means of channel estimation in demodulation processing performed by the first terminal device UE_0, thereby obtaining the following received data according to the obtained channel information:

$$Y = [ \begin{matrix}{Y}_{0} \\ {Y}_{1}\end{matrix} ] = [ \begin{matrix}{H}_{0} \\ {H}_{1}\end{matrix} ] \cdot {P}_{1} {S}_{0} + [ \begin{matrix}{I}_{0} \\ {I}_{1}\end{matrix} ] + [ \begin{matrix}{N}_{0} \\ {N}_{1}\end{matrix} ] .$$

A receiver used at a receiving end of the first terminal device is W0, and therefore, an estimated value of S₀ can be obtained:

Ŝ₀=W₀·Y.

The foregoing solution is applicable to a manner for processing received data by the first terminal device when the second terminal device collaborates with the first terminal device. The following solution is applicable to a manner for processing received data by terminal device when the second terminal device collaborates with the first terminal device and the first terminal device collaborates with the second terminal device. This embodiment is mainly applicable to an implementation scenario in which a diversity gain is obtained. In a scenario in which quality of a communications link is not good, terminal device may receive a same data message from different links, thereby improving quality of data reception performed by the terminal device, reducing a bit error rate, achieving a beneficial effect of “transmit diversity”, and obtaining a diversity gain. In a one-way collaboration mode, for example, the second terminal device collaborates with the first terminal device, the first terminal device can obtain a diversity gain. In a two-way collaboration mode, for example, the second terminal device collaborates with the first terminal device and the first terminal device collaborates with the second terminal device, both the first and second terminal devices can obtain a diversity gain.

FIG. 5 provides a schematic diagram of a specific implementation manner in which second terminal device collaborates with first terminal device in receiving first downlink data and the first terminal device collaborates with the second terminal device in receiving second downlink data. As shown in FIG. 5, a base station BS_0 performs precoding by using a joint channel of two terminal devices, and sends multiple data flows in a same time-frequency resource block. Among these data flows, target terminal device of some data flows (S₀) is first terminal device UE_0, and target terminal device of some data flows (S₁) is second terminal device UE_1. The two terminal devices receive the following data by sharing information:

$$Y = [ \begin{matrix}{Y}_{0} \\ {Y}_{1}\end{matrix} ] = [ \begin{matrix}{H}_{0} \\ {H}_{1}\end{matrix} ] \cdot [ {P}_{1} , {P}_{2} ] \cdot [ \begin{matrix}{S}_{0} \\ {S}_{1}\end{matrix} ] + [ \begin{matrix}{I}_{1} \\ {I}_{2}\end{matrix} ] + [ \begin{matrix}{N}_{0} \\ {N}_{1}\end{matrix} ] ,$$

where P₁ and P₂ are precoding matrixes of S₀ and S₁. The base station BS_0 may design the precoding matrixes by using some criteria. For example, a precoding matrix is obtained in a manner based on SVD decomposition, which can maximize a data throughput. Assuming that a dimension of a combined channel is N×M, decomposition may be performed as follows:

$$[ \begin{matrix}{H}_{0} \\ {H}_{1}\end{matrix} ] = U \cdot \sum \cdot V ,$$

where dimensions of U,Σ,V are N×N, N×M, and M×M respectively. P₁ and P₂ may be selected from the front row of V, for example, if V=[V1, V2, . . . VM], P₁=[V1, V2 . . . Vn]H and P₂=[Vn+1, . . . Vk]H, k<=min(M, N).

A receiver used at a receiving end of the first terminal device UE_0 is W0, and an estimated value of S₀ can be obtained:

Ŝ₀=W₀·Y.

A receiver used at a receiving end of the second terminal device UE_1 is W1, and an estimated value of S₁ may be obtained:

Ŝ₁=W₁·Y.

This embodiment is mainly applicable to an implementation scenario in which a multiplexing gain is obtained. When quality of a communications link is good, terminal device receives different data messages from different links, thereby increasing a channel capacity, achieving a beneficial effect of “spatial multiplexing”, and obtaining a multiplexing gain. In a one-way collaboration mode, for example, the second terminal device collaborates with the first terminal, the first user equipment can obtain a multiplexing gain. In a two-way collaboration mode, for example, the second terminal device collaborates with the first terminal device and the first terminal device collaborates with the second terminal device, both the first and second terminal devices can obtain a multiplexing gain.

As optional manners, the manners for processing received data by terminal device that are provided in FIG. 4 and FIG. 5 may be applicable to embodiments of the present application, and there are other processing manners, which is not limited herein in the present application.

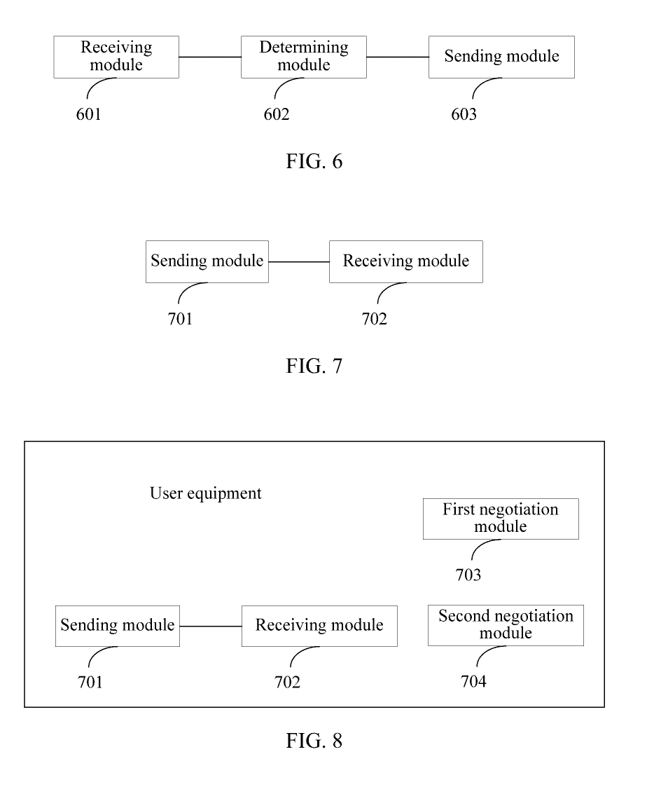

FIG. 6 is a functional block diagram of a network device according to an embodiment of the present application. The network device includes:

a receiving module 601, configured to receive a collaboration request sent by first terminal device;

a determining module 602, configured to determine, according to the collaboration request received by the receiving module, at least one second terminal device that collaborates with the first terminal device in receiving first downlink data; and

a sending module 603, configured to send a first indication message to the first terminal device, where the first indication message instructs the first terminal device to receive a first part of the first downlink data from the network device and receive a second part of the first downlink data from the second terminal device.

Optionally, the sending module 603 may be further configured to: send a second indication message to the second terminal device, where the second indication message instructs the second terminal device to forward the second part, received from the network device, of the first downlink data to the first terminal device.

Optionally, the determining module 602 is further configured to: after the receiving module receives the collaboration request from the first terminal device, determine second downlink data to be sent to the second terminal device; and determine that the first terminal device collaborates with the second terminal device in receiving the second downlink data; and the sending module 603 may be further configured to: send a third indication message to the second terminal device, where the third indication message instructs the second terminal device to receive a first part of the second downlink data from the network device and receive a second part of the second downlink data from the first terminal device.

Optionally, the sending module 603 may be further configured to: send a fourth indication message to the first terminal device, where the fourth indication message instructs the first terminal device to forward the second part, received from the network device, of the second downlink data to the second terminal device.

Optionally, the determining module 602 is specifically configured to: determine whether communication quality of the first terminal device and communication quality of the second terminal device satisfy a preset threshold in a case in which the second terminal device collaborates with the first terminal device in receiving the first downlink data and the first terminal device collaborates with the second terminal device in receiving the second downlink data. If the preset threshold is satisfied, the network device determines that the first terminal device collaborates with the second terminal device in receiving the second downlink data.

Optionally, the sending module 603 is further configured to: after the determining module determines, according to the collaboration request, the at least one second terminal device that collaborates with the first terminal device in receiving the first downlink data, send a first C-RNTI to each second terminal device, so that each second terminal device demodulates control information of the first downlink data according to the first C-RNTI; or send a first C-RNTI to at least any one of the second terminal devices, so that all the second terminal devices share the first C-RNTI.

Optionally, the first C-RNTI is a C-RNTI of the first terminal device or a C-RNTI of the second terminal device or a preset C-RNTI.

Optionally, the sending module 603 is further configured to: after the determining module determines that the first terminal device collaborates with the second terminal device in receiving the second downlink data, send a second C-RNTI to the first terminal device, so that the first terminal device demodulates control information of the second downlink data according to the second C-RNTI.

Optionally, the second C-RNTI is a C-RNTI of the second terminal device or a C-RNTI of the first terminal device or a preset C-RNTI.

Optionally, the first part of the first downlink data and the second part of the first downlink data are the same, or the first part of the first downlink data and the second part of the first downlink data are different.

The network device provided in this embodiment of the present application corresponds to the method embodiment provided in FIG. 1 of the present application, and executes the method embodiment. Therefore, for a specific process in which the network device executes the method for collaborative communication between terminal devices, reference may be made to the method embodiment, and details are not described herein again.

After receiving a collaboration request of first terminal device, the network device provided in this embodiment may determine, for the terminal device, at least one other second terminal device that collaborates with the first terminal device in receiving downlink data, and indicate, to the first terminal device by using an indication message, that the downlink data may be received separately by using the network device and the second terminal device. In this way, on a premise that a quantity of physical antennas of terminal device is not increased, quality of data reception performed by the terminal device can be improved, a bit error rate can be reduced, and a diversity gain can be obtained. In addition, a channel capacity can be increased, a beneficial effect of “spatial multiplexing” can be achieved, and a multiplexing gain can be obtained.

FIG. 7 is a functional block diagram of a terminal device according to an embodiment of the present patent application. The terminal device includes:

a sending module 701, configured to send a collaboration request to a network device; and

a receiving module 702, configured to receive a first indication message from the network device, where the first indication message instructs the terminal device to receive a first part of first downlink data from the network device; and receive a second indication message sent by the network device, where the second indication message instructs the terminal device to receive a second part of the first downlink data from another terminal device, where

the receiving module 702 is further configured to receive the first part of the first downlink data from the network device, and receive the second part of the first downlink data from the other terminal device.

Optionally, the receiving module 702 is further configured to receive a fourth indication message from the network device, where the fourth indication message instructs the terminal device to forward a second part of second downlink data received from the network device to the other terminal device.

As shown in FIG. 8, optionally, the terminal device may further include a first negotiation module 703, configured to negotiate with the other terminal device, so that the terminal device receives a second part of second downlink data from the network device and forwards the second part of the second downlink data to the other terminal device.

Optionally, the receiving module 702 may be further configured to: receive the second part of the second downlink data from the network device, after receiving the first indication message from the network device; and the sending module 701 may be further configured to: after the receiving module receives the second part of the second downlink data from the network device, send the second part of the second downlink data to the other terminal device.

Optionally, the receiving module 702 may be further configured to: after the sending module sends the collaboration request to the network device, receive a second cell radio network temporary identifier (C-RNTI) from the network device; and the receiving module 702 may be specifically configured to: after the receiving module receives the second C-RNTI from the network device, demodulate control information of the second downlink data according to the second C-RNTI.

Optionally, the second C-RNTI is a C-RNTI of the other terminal device or a C-RNTI of the terminal device or a preset C-RNTI.

Optionally, the terminal device may further include a second negotiation module 704, configured to negotiate with the other terminal device, so that the other terminal device receives the second part of the first downlink data from the network device and forwards the second part of the first downlink data to the terminal device.

The terminal device provided in this embodiment of the present application corresponds to the method embodiment provided in FIG. 2 of the present application, and executes the method embodiment. Therefore, for a specific process in which the terminal device executes the method for collaborative communication between terminal devices, reference may be made to the method embodiment, and details are not described herein again.

The terminal device provided in this embodiment may send a collaboration request to a network device, and the network device may determine at least one other terminal device that collaborates with the terminal device in receiving downlink data, and indicate, to the terminal device by using an indication message, that the downlink data may be received separately by using the network device and the other terminal device. In this way, on a premise that a quantity of physical antennas of terminal device is not increased, quality of data reception performed by the terminal device can be improved, a bit error rate can be reduced, and a diversity gain can be obtained. In addition, a channel capacity can be increased, a beneficial effect of “spatial multiplexing” can be achieved, and a multiplexing gain can be obtained.

The other terminal device provided in this embodiment of the present application corresponds to the second terminal device in the method embodiment provided in FIG. 3 of the present application, and executes the method embodiment. Therefore, for a specific process in which the terminal device executes the method for collaborative communication between terminal devices, reference may be made to the method embodiment, and details are not described herein again.

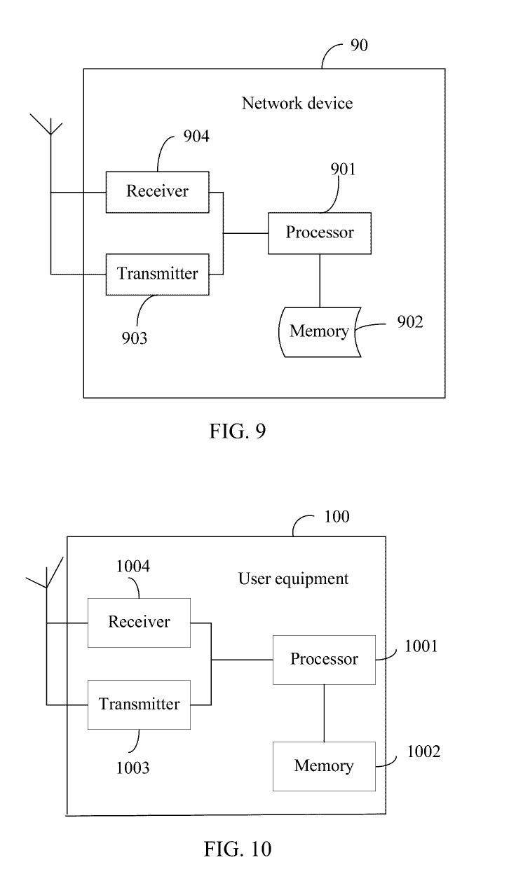

FIG. 9 is a simplified block diagram of a network device according to an embodiment of the present application.

As shown in FIG. 9, a network device 90 includes a processor 901 and a memory 902. The network device 90 may further include a transmitter 903 and a receiver 904. The transmitter 903 and the receiver 904 are connected to the processor 901. The transmitter 903 is configured to send data or information, the receiver 904 is configured to receive data or information, and the memory 902 stores an execution instruction. When the network device 90 runs, the processor 901 communicates with the memory 902, and the processor 901 invokes the execution instruction in the memory 902, so as to perform the following operations:

receiving a collaboration request sent by a first terminal device; determining, according to the collaboration request, at least one second terminal device that collaborates with the first terminal device in receiving first downlink data; and sending a first indication message to the first terminal device, where the first indication message instructs the first terminal device to receive a first part of the first downlink data from the network device and receive a second part of the first downlink data from the second terminal device.

Optionally, after the determining the at least one second terminal device that collaborates with the first terminal device in receiving the first downlink data, the following may be further performed: sending a second indication message to the second terminal device, where the second indication message instructs the second terminal device to forward the second part of the first downlink data received from the network device to the first terminal device.

Optionally, the following may be further performed: determining second downlink data to be sent to the second terminal device; determining that the first terminal device collaborates with the second terminal device in receiving the second downlink data; and sending a third indication message to the second terminal device, where the third indication message instructs the second terminal device to receive a first part of the second downlink data from the network device and receive a second part of the second downlink data from the first terminal device.

Optionally, after the determining that the first terminal device collaborates with the second terminal device in receiving the second downlink data, the following may be further performed: sending a fourth indication message to the first terminal device, where the fourth indication message instructs the first terminal device to forward the second part of the second downlink data received from the network device to the second terminal device.

Optionally, the determining that the first terminal device collaborates with the second terminal device in receiving the second downlink data may be specifically: determining whether communication quality of the first terminal device and communication quality of the second terminal device satisfy a preset threshold in a case in which the second terminal device collaborates with the first terminal device in receiving the first downlink data and the first terminal device collaborates with the second terminal device in receiving the second downlink data; and if the preset threshold is satisfied, determining that the first terminal device collaborates with the second terminal device in receiving the second downlink data.

Optionally, after the determining the at least one second terminal device that collaborates with the first terminal device in receiving the first downlink data, the following may be further performed: sending a first cell radio network temporary identifier (C-RNTI) to each second terminal device, so that each second terminal device demodulates control information of the first downlink data according to the first C-RNTI; or sending a first C-RNTI to at least any one of the second terminal devices, so that all the second terminal devices share the first C-RNTI.

Optionally, the first C-RNTI is a C-RNTI of the first terminal device, a C-RNTI of the second terminal device, or a preset C-RNTI.

Optionally, after the determining that the first terminal device collaborates with the second terminal device in receiving the second downlink data, the following may be further performed: sending a second C-RNTI to the first terminal device, so that the first terminal device demodulates control information of the second downlink data according to the second C-RNTI.

Optionally, the second C-RNTI is a C-RNTI of the second terminal device, a C-RNTI of the first terminal device, or a preset C-RNTI.

Optionally, the first part of the first downlink data and the second part of the first downlink data are the same, or the first part of the first downlink data and the second part of the first downlink data are different.

The network device provided in this embodiment of the present application corresponds to the method embodiment provided in FIG. 1 of the present application, and executes the method embodiment. Therefore, for a specific process in which the network device executes the method for collaborative communication between terminal devices, reference may be made to the method embodiment, and details are not described herein again.

After receiving a collaboration request of the first terminal device, the network device provided in this embodiment may determine, for the first terminal device, at least one other second terminal device that collaborates with the first terminal device in receiving downlink data, and indicate, to the first terminal device by using an indication message, that the downlink data may be received separately by using the network device and the second terminal device. In this way, on a premise that a quantity of physical antennas of terminal device is not increased, quality of data reception performed by the terminal device can be improved, a bit error rate can be reduced, and a diversity gain can be obtained. In addition, a channel capacity can be increased, a beneficial effect of “spatial multiplexing” can be achieved, and a multiplexing gain can be obtained.

FIG. 10 is a simplified block diagram of a terminal device according to still another embodiment of the present application. As shown in FIG. 10, terminal device 100 provided in this embodiment includes a processor 1001 and a memory 1002. The terminal device 100 may further include a transmitter 1003 and a receiver 1004. The transmitter 1003 and the receiver 1004 are connected to the processor 1001. The transmitter 1003 is configured to send data or information, the receiver 1004 is configured to receive data or information, and the memory 1002 stores an execution instruction. When the terminal device 100 runs, the processor 1001 communicates with the memory 1002, and the processor 1001 invokes the execution instruction in the memory 1002, so as to perform the following operations:

sending a collaboration request to a network device; receiving a first indication message from the network device, where the first indication message instructs the terminal device to receive a first part of first downlink data from the network device and receive a second part of the first downlink data from another terminal device; and receiving the first part of the first downlink data, from the network device, and receiving the second part of the first downlink data from the other terminal device.

Optionally, the following may be further performed: receiving a fourth indication message from the network device, where the fourth indication message instructs the terminal device to forward a second part of second downlink data received from the network device to the other terminal device.

Optionally, the following may be further performed: negotiating with the other terminal device, so that the terminal device receives a second part of second downlink data from the network device and forwards the second part of the second downlink data to the other terminal device.

Optionally, the following may be further performed: receiving the second part of the second downlink data from the network device; and sending the second part of the second downlink data to the other terminal device.

After the sending a collaboration request to a network device, the following may be further performed: receiving a second C-RNTI from the network device; and demodulating control information of the second downlink data according to the second C-RNTI.

Optionally, the second C-RNTI is a C-RNTI of the other terminal device, a C-RNTI of the terminal device, a preset C-RNTI.

Optionally, the following may be further performed: negotiating with the other terminal device, so that the other terminal device receives the second part of the first downlink data from the network device and forwards the second part of the first downlink data to the terminal device.

The terminal device provided in this embodiment of the present application corresponds to the method embodiment provided in FIG. 2 of the present application, and executes the method embodiment. Therefore, for a specific process in which the terminal device executes the method for collaborative communication between terminal devices, reference may be made to the method embodiment, and details are not described herein again.

The terminal device provided in this embodiment may send a collaboration request to a network device, and the network device may determine, for the terminal device, at least one other terminal device that collaborates with the terminal device in receiving downlink data, and indicate, to the terminal device by using an indication message, that the downlink data may be received separately by using the network device and the other terminal device. In this way, on a premise that a quantity of physical antennas of the terminal device is not increased, quality of data reception performed by the terminal device can be improved, a bit error rate can be reduced, and a diversity gain can be obtained. In addition, a channel capacity can be increased, a beneficial effect of “spatial multiplexing” can be achieved, and a multiplexing gain can be obtained.

The other terminal device provided in this embodiment of the present application corresponds to the method embodiment provided in FIG. 3 of the present application, and executes the method embodiment. Therefore, for a specific process in which the terminal device executes the method for collaborative communication between terminal devices, reference may be made to the method embodiment, and details are not described herein again.

The present patent application further provides an embodiment of a system for collaborative communication between terminal devices, including the network device shown in FIG. 6, and the terminal device shown in FIG. 7 or FIG. 8.

The present patent application further provides an embodiment of another system for collaborative communication between terminal devices, including the network device shown in FIG. 9, and the terminal device shown in FIG. 10.

For each device in the system provided in the foregoing embodiments, reference may be made to a related description in the foregoing device embodiments, and details are not described herein again.

According to the system for collaborative communication between terminal devices provided in this embodiment of the present application, after receiving a collaboration request of first terminal device, a network device may determine, for the terminal device, at least one other second terminal device that collaborates with the first terminal device in receiving downlink data, and indicate, to the first terminal device by using an indication message, that the downlink data may be received separately by using the network device and the second terminal device. In this way, on a premise that a quantity of physical antennas of terminal device is not increased, quality of data reception performed by the terminal device can be improved, a bit error rate can be reduced, and a diversity gain can be obtained. In addition, a channel capacity can be increased, a beneficial effect of “spatial multiplexing” can be achieved, and a multiplexing gain can be obtained.

Persons of ordinary skill in the art may understand that all or some of the steps of the method embodiments may be implemented by a program instructing relevant hardware. The program may be stored in a computer-readable storage medium. When the program runs, the steps of the method embodiments are performed. The foregoing storage medium includes: any medium that can store program code, such as a ROM, a RAM, a magnetic disk, or an optical disc.

Finally, it should be noted that the foregoing embodiments are merely intended for describing the technical solutions of the present patent application, but not for limiting the present patent application. Although the present patent application is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present patent application.

What is claimed is:

1. A method for collaborative communication between a network device and two or more terminal devices, comprising:
receiving, by the network device, a collaboration request from a first terminal device;
determining, by the network device according to the collaboration request, a second terminal device that collaborates with the first terminal device in receiving downlink data; and
sending, by the network device, a first indication message to the first terminal device, wherein the first indication message instructs the first terminal device to receive a first part of the downlink data from the network device and receive a second part of the downlink data from the second terminal device.

2. The method according to claim 1, further comprising:
sending, by the network device, a second indication message to the second terminal device, wherein the second indication message instructs the second terminal device to forward the second part of the first downlink data to the first terminal device.

3. The method according to claim 1, further comprising:
determining, by the network device, second downlink data to be sent to the second terminal device;
determining, by the network device, that the first terminal device collaborates with the second terminal device in receiving the second downlink data; and
sending, by the network device, a third indication message to the second terminal device, wherein the third indication message instructs the second terminal device to receive a first part of the second downlink data from the network device and receive a second part of the second downlink data from the first terminal device.

4. The method according to claim 3, further comprising:
sending, by the network device, a fourth indication message to the first terminal device, wherein the fourth indication message instructs the first terminal device to forward the second part of the second downlink data to the second terminal device.

5. The method according to claim 3, wherein determining that the first terminal device collaborates with the second terminal device in receiving the second downlink data comprises:
determining, by the network device, whether communication quality of the first terminal device and communication quality of the second terminal device satisfy a preset threshold when the second terminal device collaborates with the first terminal device in receiving the first downlink data and the first terminal device collaborates with the second terminal device in receiving the second downlink data; and
if the preset threshold is satisfied, determining, by the network device, that the first terminal device collaborates with the second terminal device in receiving the second downlink data.

6. The method according to claim 1, further comprising:
sending, by the network device, a first cell radio network temporary identifier (C-RNTI) to the second terminal device.

7. The method according to claim 6, wherein the first C-RNTI is one of the following:
a C-RNTI of the first terminal device,
a C-RNTI of the second terminal device, or
a preset C-RNTI.

8. The method according to claim 3, further comprising:
sending, by the network device, a second C-RNTI to the first terminal device so that the first terminal device demodulates control information of the second downlink data according to the second C-RNTI.

9. The method according to claim 8, wherein the second C-RNTI is one of the following:
a C-RNTI of the second terminal device, or
a C-RNTI of the first terminal device, or
a preset C-RNTI.

10. A network device, comprising:
a processor, a receiver and a transmitter;
wherein the receiver is configured to receive a collaboration request from a first terminal device;
wherein the processor is configured to determine, according to the collaboration request, a second terminal device that collaborates with the first terminal device in receiving first downlink data; and
wherein the transmitter is configured to transmit a first indication message to the first terminal device, wherein the first indication message instructs the first terminal device to receive a first part of the first downlink data from the network device and receive a second part of the first downlink data from the second terminal device.

11. The network device according to claim 10, wherein the transmitter is further configured to:
transmit a second indication message to the second terminal device, wherein the second indication message instructs the second terminal device to forward the second part of the first downlink data received from the network device to the first terminal device.

12. The network device according to claim 10, wherein the processor is further configured to:
determine second downlink data to be sent to the second terminal device;
determine that the first terminal device collaborates with the second terminal device in receiving the second downlink data; and
wherein the transmitter is further configured to:
transmit a third indication message to the second terminal device, wherein the third indication message instructs the second terminal device to receive a first part of the second downlink data from the network device and receive a second part of the second downlink data from the first terminal device.

13. The network device according to claim 12, wherein the transmitter is further configured to:
transmit a fourth indication message to the first terminal device, wherein the fourth indication message instructs the first terminal device to forward the second part of the second downlink data to the second terminal device.

14. The network device according to claim 13, wherein the processor is further configured to:
determine whether communication quality of the first terminal device and communication quality of the second terminal device satisfy a preset threshold when the second terminal device collaborates with the first terminal device in receiving the first downlink data and the first terminal device collaborates with the second terminal device in receiving the second downlink data; and
if the preset threshold is satisfied, determine that the first terminal device collaborates with the second terminal device in receiving the second downlink data.

15. The network device according to claim 10, wherein the transmitter is further configured to:
transmit a first cell radio network temporary identifier (C-RNTI) to the second terminal device, so that the second terminal device demodulates control information of the first downlink data according to the first C-RNTI.

16. The network device according to claim 15, wherein the first C-RNTI is one of the following:
a C-RNTI of the first terminal device,
a C-RNTI of the second terminal device, or
a preset C-RNTI.

17. The network device according to claim 12, wherein the transmitter is further configured to:
transmit a second C-RNTI to the first terminal device, so that the first terminal device demodulates control information of the second downlink data according to the second C-RNTI.

18. The network device according to claim 17, wherein the second C-RNTI is one of the following:
a C-RNTI of the second terminal device,
a C-RNTI of the first terminal device, or
a preset C-RNTI.
